(19) United States
(12) Patent Application Publication
(10) Pub. No.: US 2013/0073729 A1
(43) Pub. Date: Mar. 21, 2013

(54) USER TERMINAL, AND METHOD AND APPARATUS FOR CONTROLLING THE SOFTWARE MANAGEMENT THEREOF

(71) Applicant: Yong Yun, Seoul (KR)

(72) Inventor: Yong Yun, Seoul (KR)

(73) Assignee: GYEYEONG TECHNOLOGY & INFORMATION CO., LTD., Seoul (KR)

(21) Appl. No.: 13/698,698

(22) PCT Filed: May 18, 2011
(86) PCT No.: PCT/KR2011/003692

§ 371 Date: Nov. 19, 2012

(30) Foreign Application Priority Data
May 19, 2010 (KR) 10-2010-0046831
Dec. 21, 2010 (KR) 10-2010-0131214

(51) Int. Cl. G06F 15/173

(52) U.S. Cl. 709/225

(57) ABSTRACT

The present invention relates to a method and apparatus for software management and control and, more particularly, to a method and apparatus for software management and control that control multiple office computers or user terminals connected to an internal corporate network in various ways, for example, by forcing an idle user terminal occupying a connection to software running on a central server to release the connection wherein the central server performs such control operations by providing control messages that control processes running on user terminals. In the present invention, an idle user terminal, which is connected to software running on the central server but does not use the software for a given time or more, is monitored and forced to release the connection to the software. Hence, it is possible to effectively increase the number of users capable of accessing the software.

### TECHNICAL FIELD

The present invention relates to a method and apparatus for software management and control and, more particularly, to a method and apparatus for software management and control that control multiple office computers or user terminals connected to an internal corporate network in various ways by automatically installing a needed business program, uninstalling an unauthorized program, and forcing an idle user terminal with an open connection to software running on a central server to release the connection wherein the central server performs such control operations by providing control messages that control processes running on user terminals.

### BACKGROUND ART

It is necessary to install various business software programs necessary for corporate members performing their duties in multiple office computers connected to an internal corporate network. It is also necessary to remove or uninstall programs that are unrelated with business duties or are unauthorized from the office computers. Corporations deploy various software control platforms that monitor office computers used by corporate members to manage programs to be installed or uninstalled.

To prevent unauthorized installation and use of software, various schemes have been disclosed. In a widely known scheme, a software usage code that is created using a unique identification code of a computer is assigned to authorized software; and the software usage code is checked in real-time against the identification code of a computer executing the software. This scheme can invalidate license reproduction by unauthorized computers, and prevent unauthorized software use violating the license agreement.

In another scheme for preventing unauthorized software installation, license management is performed in a unitary manner by a central management apparatus connected through a network (licenses are not issued to individual computers). In this scheme, when a user terminal on the network issues a software use request, the number of copies specified in the license agreement can be checked and the software use request may be permitted or denied according to the result. Hence, the number of computers simultaneously running the software and the software usage limit may be set, and unauthorized usage exceeding the limits may be blocked.

However, in existing software management schemes, each user has to personally install necessary software in their user terminal or uninstall software therefrom according to a right assigned to the user terminal. That is, a user has to directly manage and control a user terminal according to a pre-assigned right. In the event that a user does not accurately understand the usage limit of an existing software management scheme, the user may have difficulty in performing business tasks when a problem arises during installation or use of software.

Additionally, in the case that an equipment manages and runs software accessible by multiple user terminals via a network, as the number of user terminals simultaneously accessing the software is limited, when the number of user terminals currently accessing the software reaches a preset maximum limit, a user in definite need of utilizing the software may be prevented from accessing the software.

### DISCLOSURE OF INVENTION

### Technical Problem

The present invention has been made in view of the above problems, and an object of the present invention is to provide a method and apparatus for software management and control that periodically monitor multiple user terminals connected to an internal corporate network and perform software installation or uninstallation according to preset software usage rights.

Another object of the present invention is to provide a method and apparatus for software management and control that automatically execute a process for program installation or uninstallation in the background without UI screen display so that the user of a user terminal is not aware of ongoing program installation or uninstallation.

Still another object of the present invention is to provide a method and apparatus for software management and control that force a user terminal that is connected to software running on a central server but is not used for a given time or more to release the connection to the software to thereby enable more users to efficiently access the software.

### Technical Solution

To achieve the above objects, an aspect of the present invention is to provide a software access control method, for a software providing apparatus that provides software accessible by multiple user terminals on a network and manages and controls connections between the software and user terminals, including: (a) monitoring user terminals; (b) finding an idle user terminal that is connected to software running on the software providing apparatus but does not use the software for a given time or more on the basis of results from (a) monitoring, and determining, when an idle user terminal is found, to force the idle user terminal to release the connection to the software; (c) sending a process creation request for storing intermediate processing results obtained using the software and releasing the connection to the software to the idle user terminal on the basis of results from (b) determining; and (d) providing control messages, which are to be applied to a process for storing intermediate processing results and releasing the connection to the software, to the idle user terminal.

(a) monitoring user terminals may include (a1) receiving identification codes of the user terminals and current states of the connection to the software and usage thereof from the user terminals at regular intervals.

The software access control method may further include (e) temporarily storing, when a forced release request is received from the idle user terminal after (d) providing, intermediate processing results of the idle user terminal, and forcibly releasing the connection to the software occupied by the idle user terminal.

Another aspect of the present invention is to provide a software access control method, for a user terminal that is connected to software provided by a software providing apparatus connected with the user terminal through a network, including: (a) sending, in response to a monitoring query from the software providing apparatus, an identification code and current usage state of the software to the software providing apparatus; (b) receiving, when the software is not used for a given time or more, a process creation request for forced release of the connection to the software from the software providing apparatus, and creating, upon reception of the request, a process for temporarily storing intermediate processing results and forced connection release; and (c) receiving a control message from the software providing apparatus, and inserting the received control message into the process for temporarily storing intermediate processing results and forced connection release.

The software access control method may further include (d) sending, after (c) receiving, a request for temporarily storing intermediate processing results and forced connection release to the software providing apparatus.

Still another aspect of the present invention is to provide a software providing apparatus, which provides software accessible by multiple user terminals on a network and manages and controls connections between the software and user terminals, including: a monitoring module finding an idle user terminal that is connected to software running on the software providing apparatus but does not use the software for a given time or more, and determining, when an idle user terminal is found, to force the idle user terminal to release the connection to the software; a remote control module sending a process creation request for storing intermediate processing results obtained using the software and releasing the connection to the software to the idle user terminal according to determination made by the monitoring module, and providing control messages, which are to be applied to a process for storing intermediate processing results and releasing the connection to the software, to the idle user terminal; and a server communication module performing data transmission and reception between the monitoring module or remote control module and a user terminal.

The remote control module may include: a disconnection handler temporarily storing, when a forced release request is received from the idle user terminal, intermediate processing results of the idle user terminal, and forcibly releasing the connection to the software occupied by the idle user terminal; a process requester sending a process creation request for forcibly releasing the connection to the software to the idle user terminal; and a message inserter providing control messages, which are to be applied to a process for storing intermediate processing results and releasing the connection to the software, to the idle user terminal.

The software providing apparatus may further include a database storing intermediate processing results of a user terminal that is to be forcibly logged off by the disconnection handler.

Yet another aspect of the present invention is to provide a user terminal, which is controlled by a software providing apparatus connected through a network, including: a monitoring response module sending, in response to a monitoring query from the software providing apparatus, an identification code and current usage state of specific software to the software providing apparatus; a process management module receiving, when the software is not used for a given time or more, a process creation request for forced release of the connection to the software from the software providing apparatus, creating, upon reception of the request, a process for temporarily storing intermediate processing results and forced connection release, receiving a control message from the software providing apparatus, and inserting the received control message into the process for temporarily storing intermediate processing results and forced connection release; and a terminal communication module performing data transmission and reception between the monitoring response module or process management module and the software providing apparatus.

The process management module may include: a process creator creating a process for temporarily storing intermediate processing results and forced connection release; a process handler advancing execution of the process created by the process creator; and a message handler inserting a control message received from the software providing apparatus into the process for temporarily storing intermediate processing results and forced connection release.

### Advantageous Effects

In a feature of the present invention, the software management and control apparatus periodically monitors multiple user terminals connected to a network such as a corporate network so as to install an authorized program in the user terminals or uninstall an unauthorized program from the user terminals according to usage rights assigned to the users. Hence, it is possible to efficiently manage and control software installed in the user terminals.

In another feature of the present invention, when a process for program installation or uninstallation is executed in a user terminal, the installation or uninstallation process is automatically executed in the background without UI screen display. Hence, program installation or uninstallation may be performed without the user being aware.

In another feature of the present invention, an idle user terminal, which is connected to software running on a central server but does not use the software for a given time or more, is monitored and forced to release the connection to the software. Hence, it is possible to effectively increase the number of users capable of accessing the software.

### BRIEF DESCRIPTION OF THE DRAWINGS

FIG. 1 is a simplified view of a networked system according to an embodiment of the present invention.

FIG. 2 is a block diagram of a software management and control apparatus and a user terminal connected thereto according to an embodiment of the present invention.

FIG. 3 is a block diagram of a software providing apparatus and a user terminal connected thereto according to another embodiment of the present invention.

FIG. 4 is a flowchart of a software management and control method in relation to the embodiment of FIG. 2.

FIGS. 5 and 6 illustrate processes for program installation in relation to the embodiment of FIG. 2.

FIG. 7 is a flowchart of a procedure for software management and control performed by the software management and control apparatus in relation to the embodiment of FIG. 2.

FIG. 8 is a flowchart of a procedure for software management and control performed by the user terminal in relation to the embodiment of FIG. 2.

FIG. 9 is a sequence diagram of a management and control procedure for authorized software preformed by the software management and control apparatus and the user terminal in relation to the embodiment of FIG. 2.

FIG. 10 illustrates stages in a software installation process in relation to the embodiment of FIG. 2.

FIG. 11 is a flowchart of a method for software access control in relation to the embodiment of FIG. 3.

FIGS. 12 and 13 illustrate processes for temporarily storing execution states in forced release of a connection to given software in relation to the embodiment of FIG. 3.

FIG. 14 is a flowchart of a procedure for software access control performed by the software providing apparatus in relation to the embodiment of FIG. 3.

FIG. 15 is a flowchart of a procedure for software access control performed by a user terminal in relation to the embodiment of FIG. 3.

FIG. 16 is a sequence diagram of a procedure for software access control preformed by the software providing apparatus and the user terminal in relation to the embodiment of FIG. 3.

FIG. 17 illustrates stages in a temporary storage process for forced release of a connection to software in relation to the embodiment of FIG. 3.

< Description of reference symbols >

100: user terminal

| | |
|---|---|
| 110: terminal communication module | 130: process management module |

| | |
|---|---|
| 131: process creator | 132: process handler |
| 133: message handler | 150: program management module |
| 151: program storage | 153: installation/removal handler |

| | |
|---|---|
| 120: terminal communication module | 140: process management module |

| | |
|---|---|
| 141: process creator | 142: process handler |
| 143: message handler | 160: monitoring response module |

200: software management and control apparatus/software providing
apparatus

| | |
|---|---|
| 210: server communication module | 240: monitoring module |
| 260: remote control module | 263: process requester |
| 265: message inserter | 261: package provider |
| 280: database | |
| 230: server communication module | 250: monitoring module |
| 270: remote control module | 273: process requester |
| 275: message inserter | 271: disconnection handler |
| 290: database | |

### MODE FOR THE INVENTION

Hereinafter, a method and apparatus for software management and control are described as exemplary embodiments of the present invention with reference to the accompanying drawings.

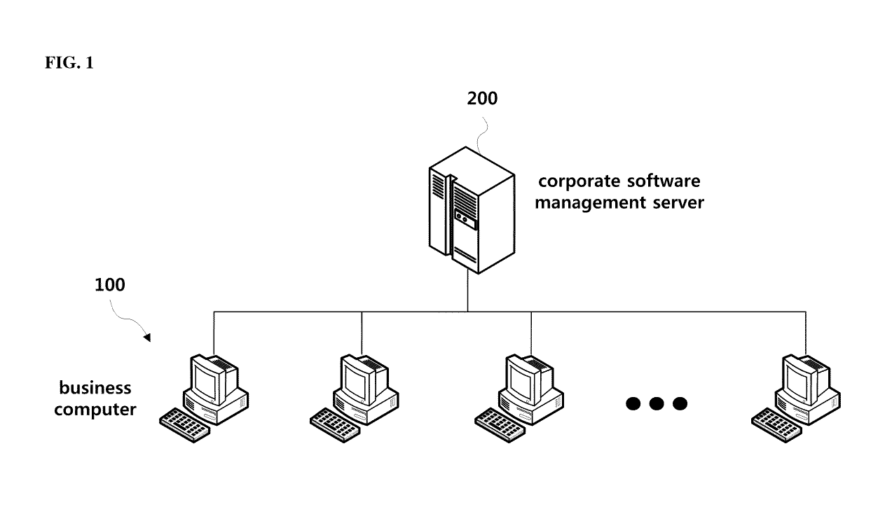

FIG. 1 is a simplified view of a networked system according to an embodiment of the present invention.

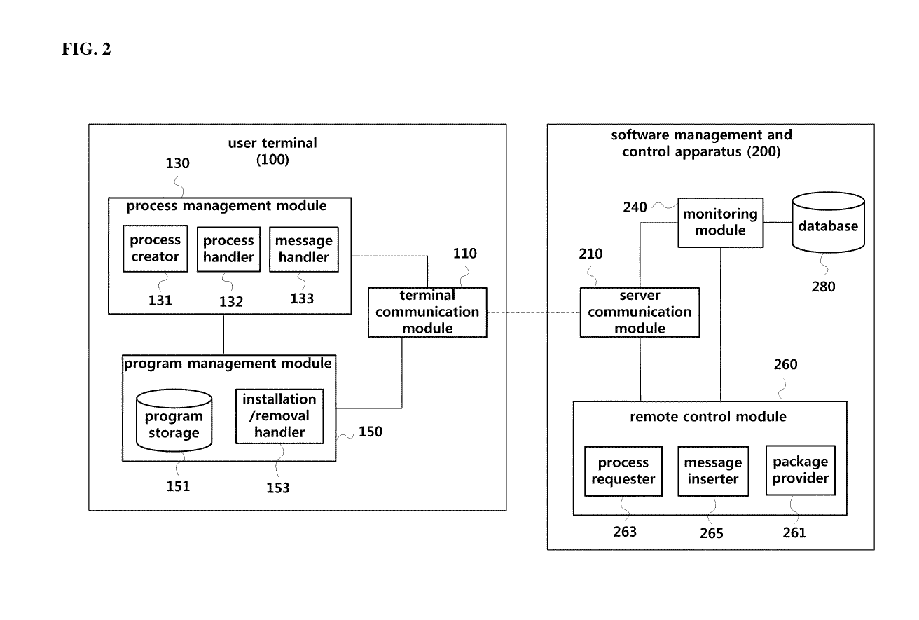

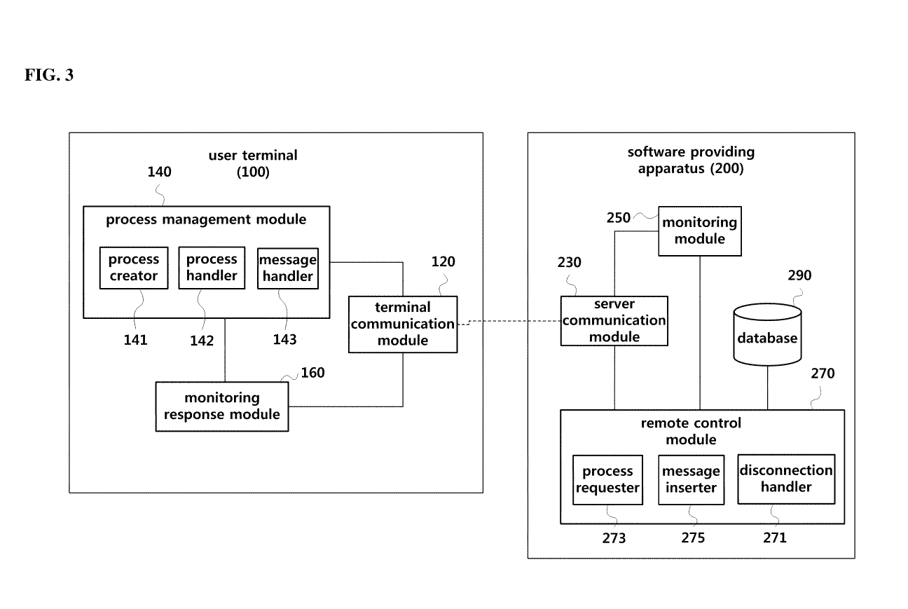

As shown in FIG. 1, the system of the present invention includes many user terminals 100 and a software management and control apparatus 200 connected therewith through a network. The software management and control apparatus 200 is a regular server device. Although the software management and control apparatus 200 is described as being connected to an internal corporate network, it is not limited thereto. The software management and control apparatus 200 in FIG. 1 is referred to as a “software management and control apparatus 200” in an embodiment of FIG. 2, and is referred to as a “software providing apparatus 200” in an embodiment of FIG. 3.

A user terminal 100 is a business computer connected with a corporate network. The user terminal 100 is normally a desktop computer equipped with a basic OS and various applications for handling business tasks, and may also be any computing device, which is connectable to the software management and control apparatus 200 through a network for interworking, such as a PDA, laptop computer or portable computer.

As described later in connection with FIGS. 2 to 17, the software management and control apparatus 200 controls a specific user terminal 100 executing various processes by sending a control message that is to be inserted into a process to be controlled to the user terminal 100 through the network. Various control operations may be applied to user terminals 100 by means of control message transmission.

As an embodiment for controlling a user terminal on a network by use of control message transmission, a software management and control apparatus 200 shown in FIG. 2 monitors lists of software installed in individual user terminals 100 at regular intervals to collect information on installed software and controls software installation and uninstallation for the user terminals 100. The software management and control apparatus 200 is a server device that manages and controls operations of multiple user terminals on the network in real time. Programs related to business tasks and programs unrelated thereto may be installed in a user terminal 100 by a corporate member or automatically. The software management and control apparatus 200 monitors programs running on a user terminal 100, controls program execution according to preset policies, and performs program uninstallation if necessary.

To smoothly perform real-time monitoring of many user terminals 100 and fast data transmission for software installation and uninstallation, it is preferable for the software management and control apparatus 200 to include a high performance microprocessor and high capacity data storage.

The software management and control apparatus 200 controls progress of a program installation or uninstallation process on a user terminal 100 by use of a control message described above.

As another embodiment for controlling a user terminal on a network by use of control message transmission, a software providing apparatus 200 shown in FIG. 3 maintains and executes software that is accessible by multiple user terminals 100 via a network. The number of user terminals simultaneously accessing the software is limited. To effectively increase the number of users capable of accessing the software, the software providing apparatus 200 monitors an idle user terminal, which is connected to the software but is not used for a given time or more, and forces the idle user terminal to release the connection to the software. Before forced connection release, the software providing apparatus 200 stores execution states of the idle user terminal in a temporary storage region allocated to the corresponding user.

The software providing apparatus 200 controls progress of a connection release process for a user terminal accessing specific provided software by use of a control message described above.

To realize a procedure for software management and control of the present invention, a client agent and a server agent may be installed respectively in a user terminal 100 and the software management and control apparatus 200 shown in FIG. 2. To realize a procedure for software access control of the present invention, a client agent and a server agent may be installed respectively in a user terminal 100 and the software providing apparatus 200 shown in FIG. 3.

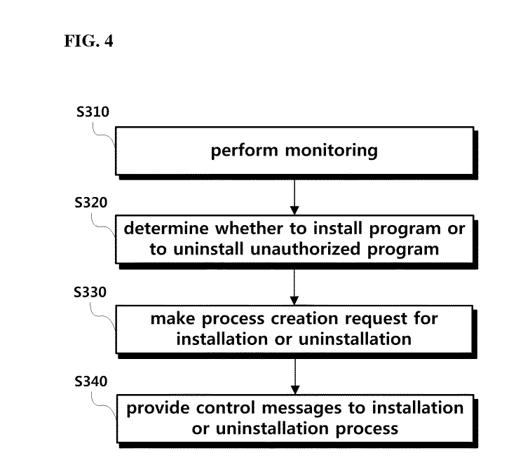

Next, a description is given of a configuration of the software management and control apparatus 200 (which controls a program installation or uninstallation process by use of a control message) and a configuration of a user terminal 100 in connection with FIG. 2. Execution of such a program installation or uninstallation process by the software management and control apparatus 200 and a user terminal 100 connected therewith is described with reference to FIGS. 4 to 10.

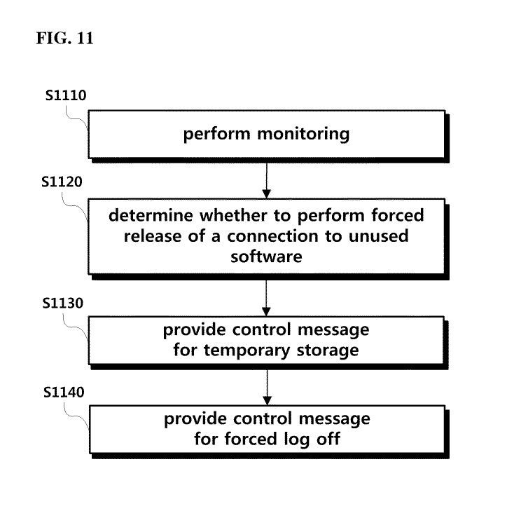

In addition, a description is given of a configuration of the software providing apparatus 200 (which provides software accessible by multiple user terminals and forces an idle user terminal to release connection to the software by use of a control message) and a configuration of a user terminal 100 with reference to FIG. 3. Execution of such a forced connection release process by the software providing apparatus 200 and a user terminal 100 connected therewith is described with reference to FIGS. 11 to 17.

FIG. 2 is a block diagram of a software management and control apparatus 200 and a user terminal 100 connected thereto according to an embodiment of the present invention.

Referring to FIG. 2, the user terminal 100 includes a terminal communication module 110 to communicate with the software management and control apparatus 200 through a network, a process management module 130 to conduct overall process management such as process creation and process termination, and a program management module 150 to conduct program installation, uninstallation and storage for the user terminal 100.

More specifically, the terminal communication module 110 sends a list of programs installed in the user terminal 100 according to periodic monitoring of the software management and control apparatus 200, receives a software package to be installed, receives a process creation request for program installation or uninstallation, and receives a message insertion request for a given process.

The process management module 130 creates a process for program installation or uninstallation and performs message insertion for process control according to requests received from the software management and control apparatus 200 via the terminal communication module 110. To achieve this, the process management module 130 includes a process creator 131 to create a process for program installation or uninstallation, a process handler 132 to initiate the process created by the process creator 131, and a message handler 133 to perform message insertion for controlling the initiated process. Here, the process handler 132 places the process for program installation or uninstallation in the background to disable screen display of the process, so that execution of the process may proceed unnoticed by the user.

The program management module 150 stores programs installed in the user terminal 100 and performs program installation or uninstallation according to a procedure performed by the process management module 130. Here, a program to be installed is downloaded through the terminal communication module 110 from the software management and control apparatus 200. To achieve this, the program management module 150 includes a program storage 151 to store programs installed in the user terminal 100, and an installation/removal handler 153 to remove a program stored in the program storage 151 and to store a downloaded program in the program storage 151.

The user terminal having the above configuration removes an unauthorized program and installs an authorized program under control of the software management and control apparatus 200.

The software management and control apparatus 200 monitors user terminals on the network according to a period set by the system manager to identify installed programs, and controls the user terminals to install or uninstall a program according to preset polices.

More specifically, the software management and control apparatus 200 includes a server communication module 210 to communicate with multiple user terminals 100 through the network, a monitoring module 240 to periodically monitor connected user terminals 100, a remote control module 260 that identifies programs installed in user terminals 100, installs a needed program in a user terminal 100 according to a policy and uninstalls an unauthorized program from a user terminal 100, and a database 280 to store program usage limits for individual user terminals 100.

In particular, the remote control module 260 includes a package provider 261 to provide, when a needed program is not installed in a user terminal 100, an installation package containing the needed program, a process requester 263 to issue a process creation request for program installation or uninstallation to a corresponding user terminal 100, and a message inserter 265 to provide an installation or uninstallation control message to an initiated process.

The software management and control apparatus 200 having the above configuration periodically monitors programs installed in user terminals 100, and controls a user terminal 100 to install a necessary program or uninstall an unauthorized program without user intervention.

FIG. 3 is a block diagram of a software providing apparatus 200 and a user terminal 100 connected thereto according to another embodiment of the present invention.

Referring to FIG. 3, the user terminal 100 includes a terminal communication module 120 to communicate with the software providing apparatus 200 through a network, a process management module 140 to conduct overall process management such as process creation and process termination, and a monitoring response module 160 to issue a response to a monitoring query from the software providing apparatus 200 for checking whether specific software to which the user terminal 100 is connected is currently used by the user terminal 100.

More specifically, the terminal communication module 120 performs data exchange between the process management module 140 or monitoring response module 160 and the software providing apparatus 200. That is, the terminal communication module 120 sends a response indicating whether specific software to which the user terminal 100 is connected is currently used in reply to a periodic monitoring query of the software management and control apparatus 200, and receives a process creation request for connection release and a control message insertion request for a given process from the software providing apparatus 200.

The process management module 140 creates a process for releasing a connection to specific software according to a request received via the terminal communication module 120 from the software providing apparatus 200, and performs message insertion for process control. Here, the software is executed by the software providing apparatus 200 and is accessed by multiple user terminals. To achieve this, the process management module 140 includes a process creator 141 to create, when a request for releasing a connection to specific software unused by the user terminal 100 for a given time or more is received from the software providing apparatus 200, a process for forced connection release (log off), a process handler 142 to initiate the process created by the process creator 141, and a message handler 143 to perform message insertion for controlling the initiated process. The process for forced connection release may have a function for storing intermediate processing results obtained using the corresponding software in a temporary storage folder of the software providing apparatus 200 before connection release. Here, the process handler 142 may place the process for forced connection release in the background to disable screen display of the process, so that execution of the process may proceed unnoticed by the user.

The monitoring response module 160 sends, as a reply to a monitoring query, an identification code of the user terminal 100 and an indication to whether connected software is currently used to the software providing apparatus 200. The data from the monitoring response module 160 is sent through the terminal communication module 120 to the software providing apparatus 200.

The user terminal 100 having the above configuration performs forced connection release operation for specific software to which the user terminal 100 is connected but not used for a given time or more by storing intermediate processing results obtained using the software in a temporary storage folder of the software providing apparatus 200 and releasing the connection to the software under control of the software providing apparatus 200.

The software providing apparatus 200 monitors user terminals on the network according to a period set by the system manager to check, for specific software that is run on the software providing apparatus 200 and accessed by multiple user terminals, whether all user terminals connected to the software are currently using the software.

More specifically, the software providing apparatus 200 includes a server communication module 230 to communicate with multiple user terminals 100 through the network, a monitoring module 250 that identifies an idle user terminal 100 that is connected to specific software run on the software providing apparatus 200 but does not use the software for a given time or more and determines to apply forced connection release operation to the idle user terminal 100 (forced log off), a remote control module 270 that sends the idle user terminal 100 a process creation request for storing intermediate processing results obtained using the software in a temporary storage folder and releasing the connection to the software according to the determination of the monitoring module 250 and provides the idle user terminal 100 with messages to control the process for temporary storage and forced connection release, and a database 290 to store intermediate processing results of an idle user terminal 100 to be forcibly disconnected according to results of operation of the remote control module 270.

In particular, the remote control module 270 includes a disconnection handler 271 to perform operations related with storing intermediate processing results of a user terminal 100 and forced connection release thereof, a process requester 273 to send a process creation request for forced software connection release to an idle user terminal 100, and a message inserter 275 to send an idle user terminal 100 messages to control the process for temporary storage and forced connection release.

The software providing apparatus 200 having the above configuration monitors user terminals 100 that are connected to specific software run on the software providing apparatus 200, identifies a user terminal 100 that is connected to the software but does not use the software for a given time or more, and forces the identified user terminal 100 to release the connection to the software.

Hereinafter, a software management and control method according to the embodiment of FIG. 2 is described with reference to FIGS. 4 to 10; and a software access control method according to the embodiment of FIG. 3 is described with reference to FIGS. 11 to 17.

FIG. 4 is a flowchart of a software management and control method in relation to the embodiment of FIG. 2.

Referring to FIG. 4, the software management and control method includes: monitoring (S310); determining whether to install an uninstalled program or to uninstall an unauthorized program that is already installed (S320); making a process creation request for program installation or uninstallation (S330); and providing control messages to an installation or uninstallation process (S340).

More specifically, at step S310 for monitoring, the software management and control apparatus periodically monitors user terminals on the network to identify programs installed in the user terminals. The software management and control apparatus sends a request for a terminal identification code and a list of currently installed programs to a user terminal, and the user terminal sends the requested data to the software management and control apparatus.

At step S320 for determining whether to install an uninstalled program or to uninstall an unauthorized program that is already installed, program installation or uninstallation is determined by comparing response data received from a user terminal with information on program usage rights of the corresponding user pre-stored in a database. The software management and control apparatus uses the terminal identification code to identify program usage rights assigned to a particular user and user terminal thereof, and determines whether to install a program or uninstall a program on the basis of the list of installed programs and program usage rights.

At step S330 for issuing a process creation request for program installation or uninstallation, the software management and control apparatus having determined to install or uninstall a program sends a process creation request for program installation or uninstallation to a corresponding user terminal.

At step S340 for providing control messages to an installation or uninstallation process (S340), to control the installation or uninstallation process on the user terminal, the software management and control apparatus sends the user terminal a message that is to be inserted into the installation or uninstallation process. When the installation or uninstallation process is initiated, the software management and control apparatus provides a user action for process execution to the corresponding thread, so that execution of the process may proceed without user intervention.

To perform step S340, it is necessary for the software management and control apparatus to have information on the program installation or uninstallation process in advance.

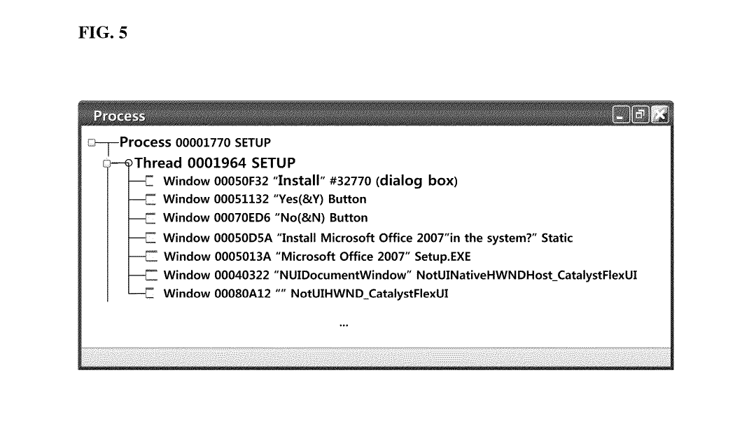

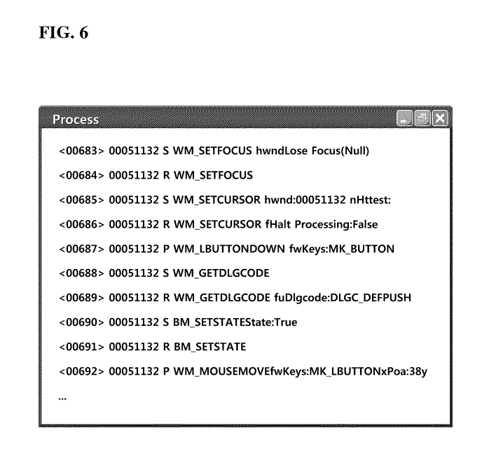

FIGS. 5 and 6 illustrate processes for program installation in relation to the embodiment of FIG. 2.

Referring to FIG. 5, an installation process for a program is composed of one or more threads indicated by the corresponding software package, and the threads specify an installation file, windows to be displayed during installation, and events associated with buttons in a window. With these, the software management and control apparatus may obtain various information regarding installation stages of the installation process. Collected information regarding installation stages is pre-stored in the software management and control apparatus, and the manager examines this information and generates messages to be inserted into threads corresponding to a sequence of user actions needed for installation as illustrated in FIG. 6 and stores the generated messages.

Through the above-described steps, the software management and control apparatus installs an authorized program in user terminals on a network or uninstalls an unauthorized program from the user terminals according to usage rights assigned to user terminals. Next, a procedure for software management and control performed by the apparatus is described in consideration of an authorized program and an unauthorized program.

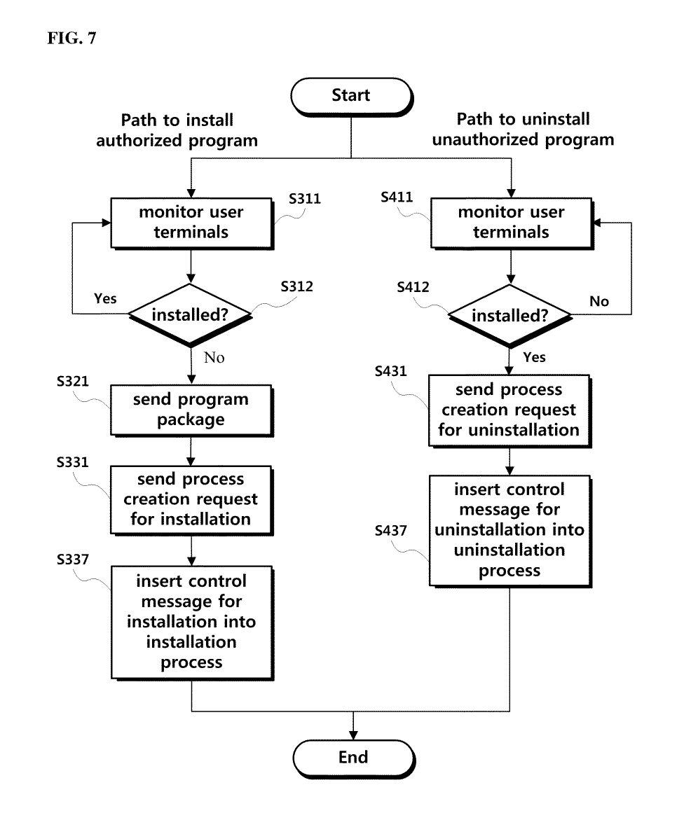

FIG. 7 is a flowchart of a procedure for software management and control performed by the software management and control apparatus in relation to the embodiment of FIG. 2.

First, for management and control of an authorized program, the software management and control apparatus monitors user terminals at regular intervals (S311), and checks whether an authorized program is not installed in a user terminal with reference to program usage rights assigned to the user terminal (S312). When the authorized program is installed in all user terminals, the software management and control apparatus continues monitoring. When the authorized program is not installed in a user terminal, the software management and control apparatus sends a program package to be installed to the user terminal (S321). The software management and control apparatus sends a process creation request for program installation to the user terminal (S331). That is, the software management and control apparatus requests the user terminal to execute an installation file contained in the program package. After the user terminal creates an installation process, the software management and control apparatus sends a control message for installation to the user terminal and requests the user terminal to insert the control message into the installation process (S337).

Second, for management and control of an unauthorized program, the software management and control apparatus monitors user terminals at regular intervals (S411), and checks whether an unauthorized program is installed in a user terminal with reference to program usage rights assigned to the user terminal (S412). When an unauthorized program is not installed in all user terminals, the software management and control apparatus continues monitoring. When an unauthorized program is installed in a user terminal, the software management and control apparatus sends a process creation request for program uninstallation to the user terminal (S431). That is, the software management and control apparatus requests the user terminal to execute an uninstallation file contained in the program package. After the user terminal creates an uninstallation process, the software management and control apparatus sends a control message for uninstallation to the user terminal and requests the user terminal to insert the control message into the uninstallation process (S437).

Through the above-described steps, the software management and control apparatus installs an authorized program in a user terminal or uninstalls an unauthorized program from a user terminal according to usage rights assigned to user terminals. Next, a procedure for software management and control performed by a user terminal under control of the software management and control apparatus is described in consideration of an authorized program and an unauthorized program.

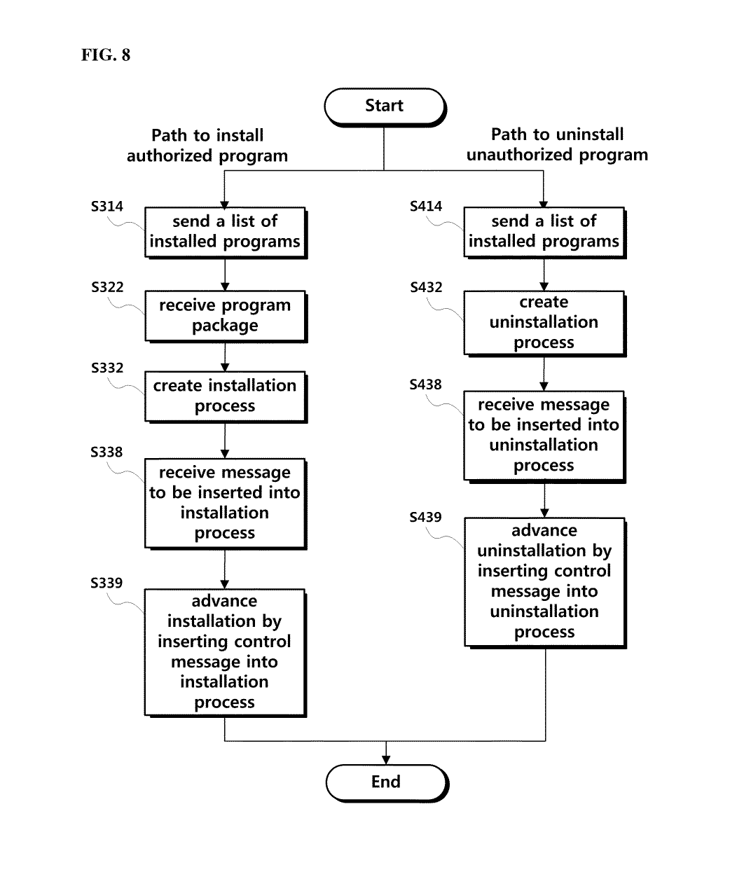

FIG. 8 is a flowchart of a procedure for software management and control performed by a user terminal in relation to the embodiment of FIG. 2.

First, for management and control of an authorized program, the user terminal sends a list of currently installed programs, as a reply to a monitoring query, to the software management and control apparatus (S314). The user terminal receives a program package to be installed from the software management and control apparatus (S322), and creates an installation process as requested (S332). The user terminal receives a control message for installation progression from the software management and control apparatus (S338), and inserts the received control message into a corresponding thread of the installation process to start installation (S339).

Second, for management and control of an unauthorized program, the user terminal sends a list of currently installed programs, as a reply to a monitoring query, to the software management and control apparatus (S414). The user terminal creates an uninstallation process in response to an uninstallation request for a program from the software management and control apparatus (S432). The user terminal receives a control message for uninstallation from the software management and control apparatus (S438), and inserts the received control message into a corresponding thread of the uninstallation process to start uninstallation (S439).

Through the above-described steps, the user terminal installs an authorized program and uninstalls an unauthorized program under control of the software management and control apparatus. Next, a procedure for software management and control performed between a user terminal and the software management and control apparatus is described in consideration of authorized software.

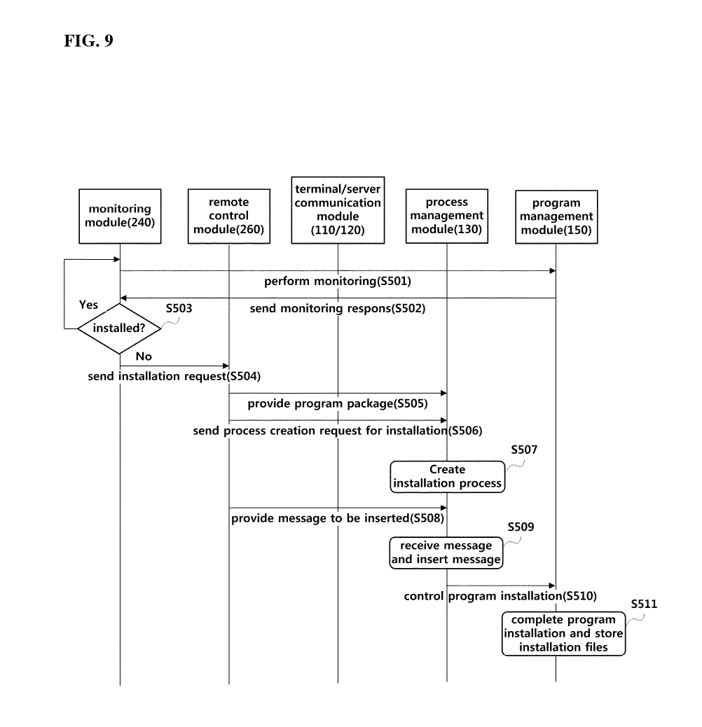

FIG. 9 is a sequence diagram of a management and control procedure for authorized software preformed by the software management and control apparatus and the user terminal in relation to the embodiment of FIG. 2.

Here, only installation of an authorized program is illustrated for ease of description. In the case of uninstallation of an unauthorized program, step S505 of providing a program package is omitted and other steps are the same except for a difference in types of processed data.

As shown in FIG. 9, in a management and control procedure for authorized software preformed between the software management and control apparatus and the user terminal, the monitoring module 240 of the software management and control apparatus performs monitoring via the server communication module 210 in communication with the terminal communication module 110 of the user terminal (S501). The program management module 150 of the user terminal sends a list of installed programs as a monitoring response via the terminal communication module 110 to the monitoring module 240 (S502).

The monitoring response includes an identification code of the user terminal and a list of programs installed therein. The monitoring module 240 checks whether a given program is installed in the user terminal with reference to program usage rights assigned to the user of the user terminal stored in a database (S503). When the given program is already installed in the user terminal, the monitoring module 240 continues monitoring. When the given program is not installed in the user terminal, the monitoring module 240 requests the remote control module 260 to perform remote automatic installation of the given program (S504). According to the request from the monitoring module 240, the remote control module 260 sends a corresponding program package via the server communication module 210 to the process management module 130 of the user terminal (S505). The remote control module 260 sends a process creation request for the program package to the process management module 130 (S506).

According to the request received via the terminal communication module 110, the process management module 130 creates an installation process by executing an installation file contained in the program package (S507). Thereafter, the remote control module 260 sends a control message to the process management module 130 so that the installation process is executed in the background (S508).

The process management module 130 starts the installation process by inserting the received control message into a corresponding thread of the installation process (S509). During execution of the installation process, the process management module 130 controls the program management module 150 to conduct an installation procedure for the program including registry entry, library registration and file storage (S510). The program management module 150 completes the installation procedure for the program and stores various installation files under control of the process management module 130 (S511).

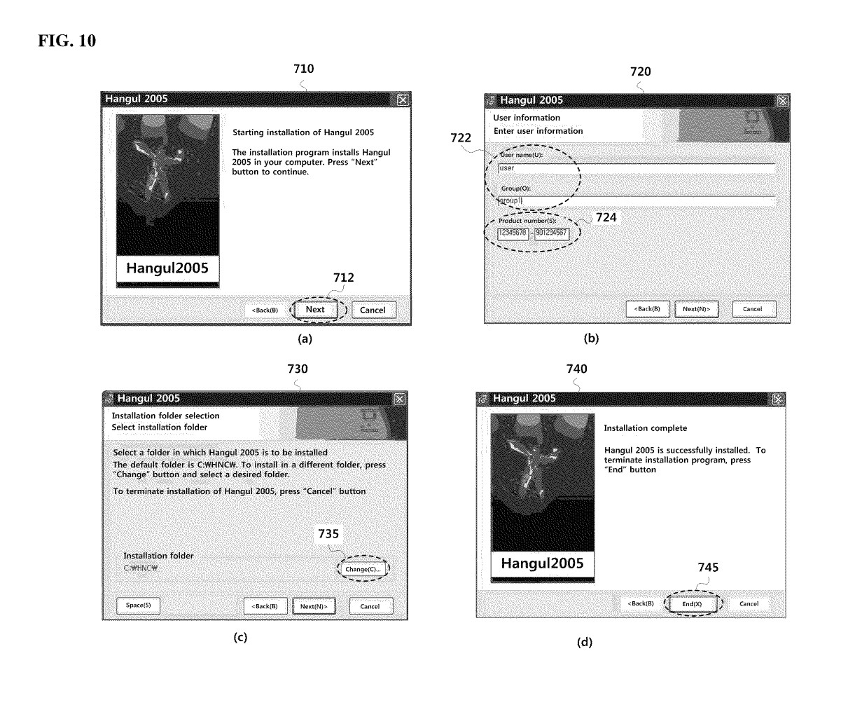

FIG. 10 illustrates stages in a software installation process in relation to the embodiment of FIG. 2.

As shown in FIG. 10, when an installation process for a given program is created and started in a user terminal, a UI window 710 for installation is displayed. To proceed to the next stage, the user has to click a form button labeled “next” 712. This corresponds to generation of a button click event in the user interface. The software management and control apparatus inserts a click event message for the button 712 into the corresponding thread to thereby produce the same effect as clicking the corresponding button without actual UI input. Thereafter, when a text input window 720 containing a user identification field 722 and a certificate number field 724 is displayed, the software management and control apparatus inserts necessary information in the form of a message into the thread according to information regarding the user and user terminal, and usage rights assigned thereto. The installed program is stored in a preset folder of the user terminal. When it is necessary to change the installation folder according to intention of the manager, the software management and control apparatus inserts a message corresponding to a click event for a button labeled “change” 735 of a corresponding window 730.

Upon completion of program installation after copying program files, a user confirmation window 740 is displayed, and the software management and control apparatus inserts a message corresponding to a click event for a button labeled “end” 745 and ends program installation.

The installation process described above is executed in the background in the user terminal. To achieve this, the display state of threads for the windows 710 to 740 is set to “false”.

FIG. 11 is a flowchart of a method for software access control in relation to the embodiment of FIG. 3.

Referring to FIG. 11, the software access control method includes: monitoring (S1110), determining whether to perform forced release of a connection to shared software (S1120), providing a control message for temporary storage (S1130), and providing a control message for forced connection release (S1140).

More specifically, at step S1110 for monitoring, the software providing apparatus 200 monitors user terminals 100 on the network according to a period set by the system manager to check, for specific software that is run on the software providing apparatus 200 and accessed by multiple user terminals 100, whether all user terminals connected to the software are currently using the software.

At step S1120 for determining whether to perform forced release of a connection to shared software, the software providing apparatus 200 identifies a user terminal 100 that is connected to the software but does not use the software. When the identified user terminal does not use the software for a given time or more, the software providing apparatus 200 sends a process creation request for forced connection release to the user terminal 100.

At step S1130 for providing a control message for temporary storage (S1130), the software providing apparatus 200 sends the user terminal 100 a control message for storing intermediate processing results obtained using the software in a temporary storage folder of the software providing apparatus 200.

That is, when a process for forced connection release is started, the software providing apparatus 200 sends a control message corresponding to a user action necessary for storing intermediate processing results to a corresponding thread, making it possible to advance the process without user intervention.

At step S1140 for providing a control message for forced connection release, after temporary storage of intermediate processing results, the software providing apparatus 200 sends a control message corresponding to a user action necessary for forced log off to the corresponding thread, making it possible to advance the process without user intervention.

To perform the above step, it is necessary for the software providing apparatus 200 to have information regarding temporary storage and connection release in advance.

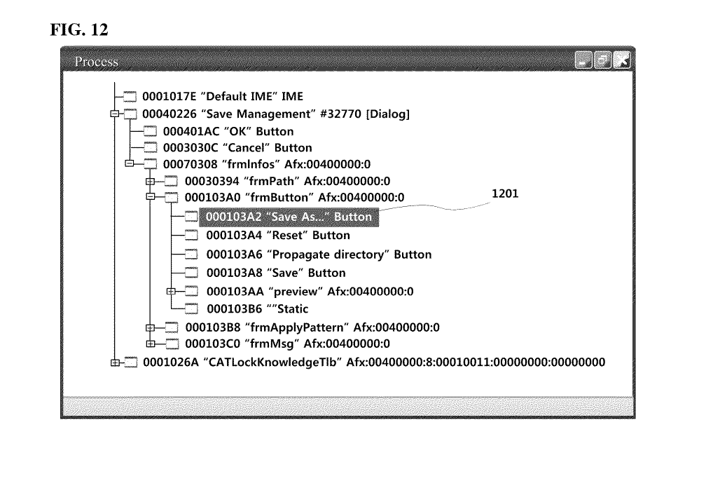

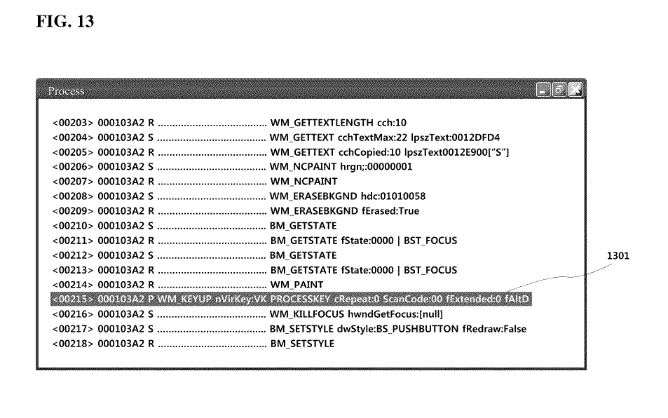

FIGS. 12 and 13 illustrate processes for temporarily storing execution states in forced release of a connection to given software in relation to the embodiment of FIG. 3.

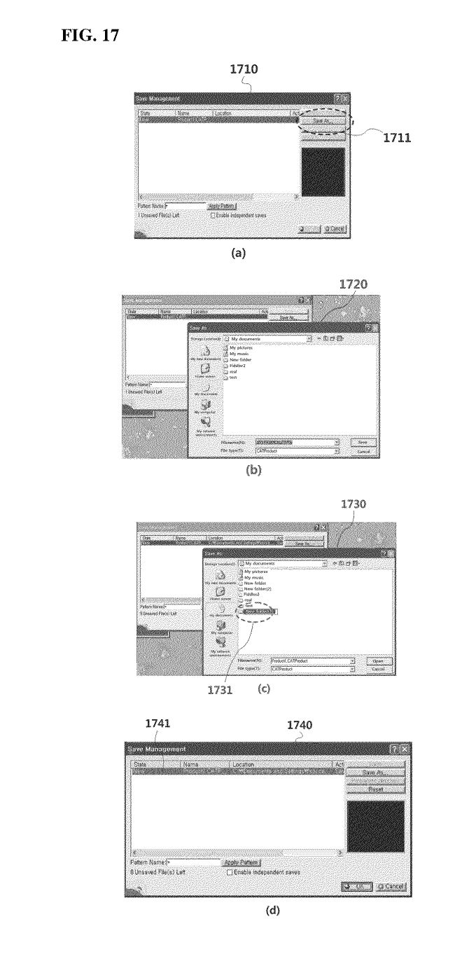

Referring to FIG. 12, the process for temporarily storing intermediate processing results is composed of one or more threads indicated by the corresponding software package, and the threads specify windows to be displayed during process execution and events associated with buttons in a window. For example, a thread indicated by a blue bar 1201 specifies a button event “Save As . . . ”, which is described later in connection with FIG. 17. With these, the software providing apparatus 200 may obtain various information regarding stages of the temporary storage process. Collected information regarding temporary storage is pre-stored in the software providing apparatus 200, and the manager examines this information and generates messages 1301 to be inserted into threads corresponding to a sequence of user actions needed for temporary storage as illustrated in FIG. 13 and stores the generated messages.

Through the above-described steps, the software providing apparatus 200 temporarily stores intermediate processing results of a user terminal in a temporary storage folder before forcibly logging off the user terminal.

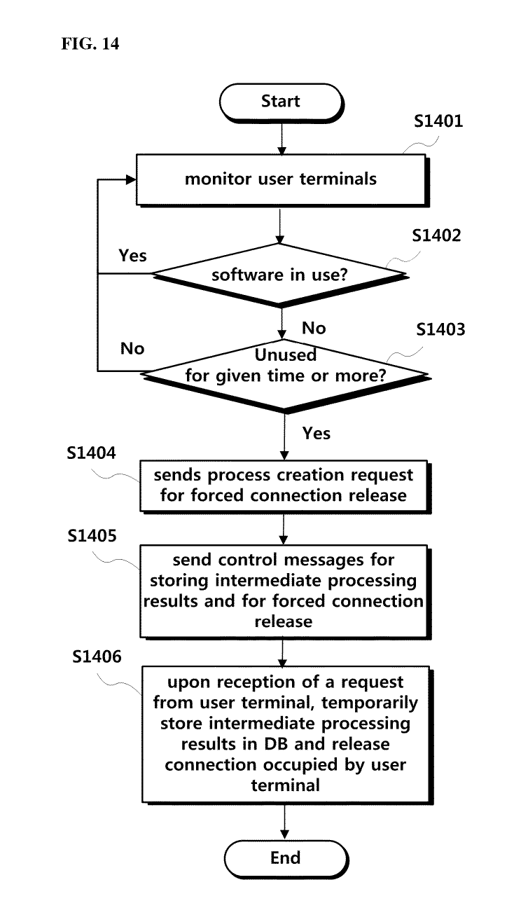

FIG. 14 is a flowchart of a procedure for software access control performed by the software providing apparatus 200 in relation to the embodiment of FIG. 3.

The software providing apparatus 200 monitors user terminals 100 on the network according to a period set by the system manager to check, for specific software that is run on the software providing apparatus 200 and accessed by multiple user terminals 100, whether all user terminals connected to the software are currently using the software (S1401). The software providing apparatus 200 finds a user terminal 100 that is connected to the software but does not uses the software (S1402). When such a user terminal 100 is not found, the software providing apparatus 200 continues monitoring. When such a user terminal 100 is found, the software providing apparatus 200 checks whether the found user terminal 100 does not use the software for a given time or more (S1403). When the found user terminal 100 does not use the software for the given time or more, the software providing apparatus 200 sends a process creation request for forced connection release to the user terminal 100 (S1404). The software providing apparatus 200 sends the user terminal 100 control messages for storing intermediate processing results obtained using the software in a temporary storage folder of the software providing apparatus 200 and for forced connection release (S1405). After reception of a request for temporary storage and forced connection release from the user terminal having executed the connection release process according to the control messages, the software providing apparatus 200 stores intermediate processing results obtained by the user terminal using the software in a temporary storage folder and releases the connection to the software occupied by the user terminal 100 (S1406).

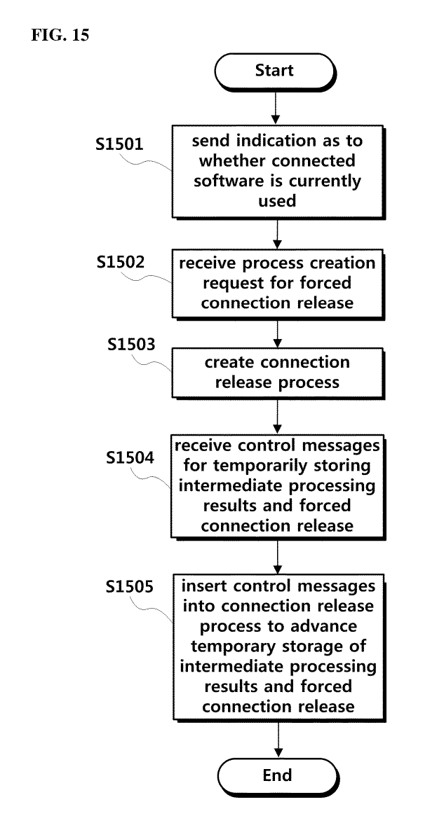

FIG. 15 is a flowchart of a procedure for software access control performed by a user terminal 100 in relation to the embodiment of FIG. 3.

A user terminal 100, which is connected to specific software that is run on the software providing apparatus 200 and accessible by multiple user terminals 100, sends, in response to a monitoring query from the software providing apparatus 200, an indication as to whether the software is currently used to the software providing apparatus 200 (S1501). When the software is not used for a given time or more, the user terminal 100 receives a process creation request for forced release of the connection to the software from the software providing apparatus 200 (S1502). According to the request, the user terminal 100 creates a connection release process (S1503), and receives control messages for temporarily storing intermediate processing results and forced connection release from the software providing apparatus 200 (S1504). After reception of the control messages, the user terminal 100 performs temporary storage of intermediate processing results and forced connection release operation by inserting the control messages into the connection release process (S1505).

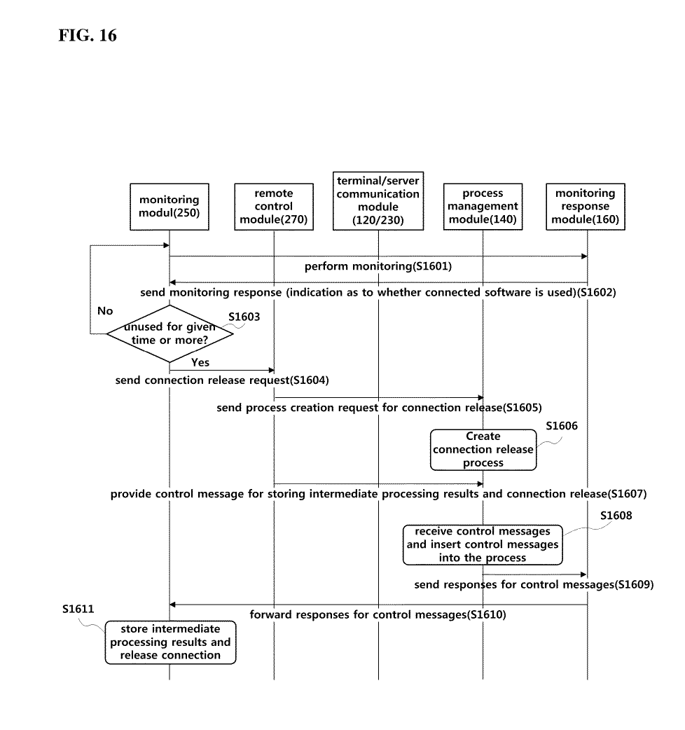

FIG. 16 is a sequence diagram of a procedure for software access control preformed between the software providing apparatus 200 and a user terminal 100 in relation to the embodiment of FIG. 3.

Referring to FIG. 16, in the software access control procedure preformed between the software providing apparatus 200 and a user terminal 100, the monitoring module 250 of the software providing apparatus 200 performs monitoring via the server communication module 230 in communication with the terminal communication module 120 of the user terminal (S1601). Here, the user terminal 100 is connected to specific software that is run on the software providing apparatus 200 and accessible by multiple user terminals 100, and monitoring is aimed at determining whether the software is currently used by the user terminal. The monitoring response module 160 of the user terminal 100 examines whether the software is currently used and sends a monitoring response indicating the examination result to the monitoring module 250 (S1602). When the software is currently used by the user terminal 100, the monitoring module 250 continues monitoring. When the user terminal 100 does not use the software while connected thereto, the monitoring module 250 checks whether the software is not used for a given time or more (S1603). When the software is not used by the user terminal 100 for the given time or more, the monitoring module 250 notifies the remote control module 270 of this (S1604). The remote control module 270 sends a process creation request for forced release of the connection to the software to the process management module 140 of the user terminal 100 (S1605). According to the request, the process management module 140 creates a connection release process (S1606), receives control messages for temporarily storing intermediate processing results and forced connection release from the remote control module 270 (S1607), and performs temporary storage of intermediate processing results and forced connection release operation by inserting the received control messages into the connection release process (S1608). During execution of the connection release process, the control messages produce the same responses as actually clicking buttons on the screen by the user confirming temporary storage of intermediate processing results and forced connection release, and such responses are sent to the monitoring response module 160 (S1609) and are forwarded to the monitoring module 250 (S1610). The software providing apparatus 200 stores the intermediate processing results of the user terminal 100 in a temporary storage folder (database) and releases the connection to the software occupied by the user terminal 100 (S1611).

FIG. 17 illustrates stages in a temporary storage process for forced release of a connection to software in relation to the embodiment of FIG. 3.

As shown in FIG. 17, when the temporary storage process is created and executed, a UI window 1710 for storage is displayed on the screen of the user terminal and a button labeled “Save As . . . ” is to be clicked. This corresponds to generation of a button click event in the user interface. The software providing apparatus 200 inserts a click event control message (as shown in FIG. 13) into the corresponding thread to thereby produce the same effect as clicking the button labeled “Save As . . . ” 1711 without actual UI input. Thereafter, when an input window 1720 for entering a folder name and file name is displayed, the software providing apparatus 200 inserts control messages into the corresponding thread so that new folder creation is selected, a new folder window 1730 is displayed, and a default folder name 1731 is input. A temporary storage completion window 1740 displays a folder name and file name 1741 for temporary storage.

As described in connection with FIGS. 4 to 10, the software management and control apparatus monitors user terminals and installs an authorized program. Uninstallation of an unauthorized program is carried out in a similar way. In addition, as described in connection with FIGS. 11 to 17, the software providing apparatus monitors user terminals and forces an idle user terminal to release a connection to shared software.

The software management and control method and apparatus, and the software access control method and software providing apparatus of the present invention may be realized as programs and stored in a computer readable storage medium such as a CD-ROM, RAM, ROM, floppy disk, hard disk or magneto-optical disc.

Hereinabove, the present invention has been described with reference to the accompanying drawings without limiting the present invention. It will be clear to those of ordinary skill in the art to which the invention pertains that various modifications may be made to the described embodiments without departing from the spirit and scope of the invention as defined in the appended claims and their equivalents.

1. A software access control method for a software providing apparatus that provides software accessible by multiple user terminals on a network and manages and controls connections between the software and user terminals, the method comprising:
(a) monitoring user terminals;
(b) finding an idle user terminal that is connected to software running on the software providing apparatus but does not use the software for a given time or more on the basis of results from (a) monitoring, and determining, when an idle user terminal is found, to force the idle user terminal to release the connection to the software;
(c) sending a process creation request for storing intermediate processing results obtained using the software and releasing the connection to the software to the idle user terminal on the basis of results from (b) determining; and
(d) providing control messages, which are to be applied to a process for storing intermediate processing results and releasing the connection to the software, to the idle user terminal.

2. The software access control method of claim 1, wherein (a) monitoring user terminals comprises (a1) receiving identification codes of the user terminals and current states of the connection to the software and usage thereof from the user terminals at regular intervals.

3. The software access control method of claim 1, further comprising (e) temporarily storing, when a forced release request is received from the idle user terminal after (d) providing, intermediate processing results of the idle user terminal, and forcibly releasing the connection to the software occupied by the idle user terminal.

4. A software access control method for a user terminal that is connected to software provided by a software providing apparatus connected with the user terminal through a network, the method comprising:
(a) sending, in response to a monitoring query from the software providing apparatus, an identification code and current usage state of the software to the software providing apparatus;
(b) receiving, when the software is not used for a given time or more, a process creation request for forced release of the connection to the software from the software providing apparatus, and creating, upon reception of the request, a process for temporarily storing intermediate processing results and forced connection release; and
(c) receiving a control message from the software providing apparatus, and inserting the received control message into the process for temporarily storing intermediate processing results and forced connection release.

5. The software access control method of claim 4, further comprising (d) sending, after (c) receiving, a request for temporarily storing intermediate processing results and forced connection release to the software providing apparatus.

6. A software providing apparatus that provides software accessible by multiple user terminals on a network and manages and controls connections between the software and user terminals, the apparatus comprising:
a monitoring module finding an idle user terminal that is connected to software running on the software providing apparatus but does not use the software for a given time or more, and determining, when an idle user terminal is found, to force the idle user terminal to release the connection to the software;
a remote control module sending a process creation request for storing intermediate processing results obtained using the software and releasing the connection to the software to the idle user terminal according to determination made by the monitoring module, and providing control messages, which are to be applied to a process for storing intermediate processing results and releasing the connection to the software, to the idle user terminal; and
a server communication module performing data transmission and reception between the monitoring module or remote control module and a user terminal.

7. The software providing apparatus of claim 6, wherein the remote control module comprises:
a disconnection handler temporarily storing, when a forced release request is received from the idle user terminal, intermediate processing results of the idle user terminal, and forcibly releasing the connection to the software occupied by the idle user terminal;
a process requester sending a process creation request for forcibly releasing the connection to the software to the idle user terminal; and
a message inserter providing control messages, which are to be applied to a process for storing intermediate processing results and releasing the connection to the software, to the idle user terminal.

8. The software providing apparatus of claim 7, further comprising a database storing intermediate processing results of a user terminal that is to be forcibly logged off by the disconnection handler.

9. A user terminal, which is controlled by a software providing apparatus connected through a network, comprising:
a monitoring response module sending, in response to a monitoring query from the software providing apparatus, an identification code and current usage state of specific software to the software providing apparatus;
a process management module receiving, when the software is not used for a given time or more, a process creation request for forced release of the connection to the software from the software providing apparatus, creating, upon reception of the request, a process for temporarily storing intermediate processing results and forced connection release, receiving a control message from the software providing apparatus, and inserting the received control message into the process for temporarily storing intermediate processing results and forced connection release; and
a terminal communication module performing data transmission and reception between the monitoring response module or process management module and the software providing apparatus.

10. The user terminal of claim 9, wherein the process management module comprises:
a process creator creating a process for temporarily storing intermediate processing results and forced connection release;
a process handler advancing execution of the process created by the process creator; and
a message handler inserting a control message received from the software providing apparatus into the process for temporarily storing intermediate processing results and forced connection release.
